(19) United States
(12) Patent Application Publication
(10) Pub. No.: US 2006/0288804 A1
(43) Pub. Date: Dec. 28, 2006

(54) Method and device for testing a run-flat tire support

(75) Inventor: Claude Roux, Decize (FR)

Correspondence Address: COHEN, PONTANI, LIEBERMAN & PAVANE, Suite 1210, 551 Fifth Avenue, New York, NY, 10176, US

(73) Assignee: Michelin Recherche et Technique S.A., Granges-Paccot (CH)

(21) Appl. No.: 11/443,853

(22) Filed: May 30, 2006

(30) Foreign Application Priority Data
May 27, 2005 (FR) 05/05377

(51) Int. Cl. G01B 5/08; G01M 17/02; G01M 19/00

(52) U.S. Cl. 73/865.9; 73/865.8; 33/555.1

(57) ABSTRACT

A method and a device for testing a run-flat tire support. At least one measurement representing at least one internal or external dimension of the support representing the effective internal diameter of said support is performed. Such measurement is performed while at least one part of the radially internal surface of the support is subjected to radial centrifugal stresses.

### FIELD OF THE INVENTION

The present invention concerns run-flat supports for vehicle tires that are mounted inside the tires, on their rims, in order to support the load in case of tire failure. More particularly, it concerns the testing of the dimensional characteristics of the supports after production.

### BACKGROUND OF THE INVENTION

The chief function of run-flat supports is to support the load in case of a severe loss of tire inflation pressure. When the tires are inflated normally, the run-flat supports must interfere as little as possible with the dynamic properties of the tires. In particular, they must remain properly centered around the rim in order to avoid any unbalancing effect, no matter what the temperature of the support and the moving speed of the vehicle. They must also be able to be mounted around the wheel rims of vehicles and easily demounted.

These two contradictory requirements impose extremely strict manufacturing tolerances on run-flat supports, particularly when it comes to their internal diameter. This internal diameter, called the nominal diameter of the support, must be less than the diameter of the mounting rim in order to ensure this tight fit, but the difference between the diameter of the rim and the nominal diameter must be slight so as to allow the support to be mounted on and demounted from the rim. Consequently, if the internal diameter of the support is slightly larger than the determined size, the support runs the risk of not fitting tightly enough on the rim. On the other hand, if the diameter is slightly smaller than the determined size, both mounting and demounting in the shop will become difficult, or even impossible.

These requirements are particularly important in the case of run-flat supports that include annular reinforcements disposed inside their base in order to withstand centrifugal stresses. An example of such supports is presented in the application EP 0 796 747 A1. These supports are made to be mounted on a rim by locking onto the corresponding portion of the rim. One may also refer to U.S. Pat. No. 5,836,366, which describes a method for mounting an assembly formed by a tire and a run-flat support onto a wheel rim wherein the two seats are of different diameters.

After having produced such run-flat supports for tires, it is necessary to test their dimensional characteristics, particularly their internal diameter. However, there is no existing method that makes it possible to do that in a way that typifies the conditions of their subsequent use.

### SUMMARY OF THE INVENTION

One aspect of the present invention is directed to a method for testing a run-flat tire support. At least one measurement representing at least one internal or external dimension of the support representing the effective internal diameter of the support is performed. The measurement is performed while at least one part of the radially internal surface of the support is subjected to radial centrifugal stresses. This ensures that the measurement performed is representative of the effective internal diameter.

Preferably, a measurement representing the internal evolute or the internal circumference of the support is performed.

The measurement chosen, the internal evolute or internal circumference of the support, corresponds to a measurement of the circumference of the radially internal surface of the support, performed while this surface is being stretched by radial centrifugal stresses. This measurement is representative of the locking onto a rim, since the support remains in contact with the rim no matter what its level of ovalization. This measurement has the advantage of providing results that are far more reproducible than direct measurements of the internal diameter of the support, which are thrown way off by these phenomena of ovalization of the support after its manufacture. This makes this measurement compatible with the extremely strict manufacturing tolerances.

More specifically, the method according to the invention can include the following steps:

the support is disposed around a tool, the tool comprising at least two parts moving radially relative to one another, each part having a radially external surface with a shape adapted to fit a circumferential portion of the radially internal surface of the support;

the moving parts are moved radially apart from one another, and the radially external surfaces of the parts are pressed against at least one circumferential portion of the radially internal surface of the support until a given stretched condition of the radially internal surface of the given support is produced; and

the measurement representing the effective internal diameter of the support is performed.

According to a first preferred embodiment, the moving parts are moved apart radially until stresses for stretching the radially internal surface of the support are applied at given values, and the corresponding displacement of the moving parts is measured.

According to a second embodiment, the moving parts are moved a given distance apart and the corresponding resultant of the stresses exerted by the radially internal surface of the support on at least one of the parts is measured.

Preferably, the measurement representing the effective internal diameter of the support is measured after a given stabilization time. This time can be between 10 and 60 seconds.

Advantageously, the radially external surface of the parts is pressed against a substantially smooth circumferential portion of the radially internal surface of the support.

As shown in the application WO 01/32450, run-flat supports often include on their internal surface wedges or ribs for facilitating both their mounting and the compromise between the aforementioned contradictory criteria. It is preferable to perform the measurements according to the invention on a part of this internal surface of the supports that is free of such wedges or ribs, in order to improve the precision and the representivity of the measurements.

Preferably, the axial height of the radially external surface of the parts being d, the stresses applied per millimeter of axial height in order to stretch the radially internal surface of the support are between 40 and 150 N/mm.

The high level of these stresses makes it possible to stretch the annular reinforcements of the support and thus perform a precise measurement of the effective diameter of the run-flat support under conditions that are typical of its mounting and its utilization. When the stresses are too weak, it is observed that the dispersion of the measurements increases due to geometric uncertainties linked, in particular, to thermal contraction phenomena during the manufacture of the supports, be they made of rubber, polyurethane or thermoplastic material. Conversely, stresses that are too strong are not representative of the conditions for the mounting and demounting of the supports.

These stresses can advantageously be between 50 and 100 N/mm for supports composed primarily of rubber-like materials.

Another aspect of the present invention is directed to a device for testing a run-flat support for a tire. The device comprises a run-flat support holder, a tool for exerting outward radial stress on at least one part of the radially internal surface of the support comprising at least two parts moving radially relative to one another so as to stretch the radially internal surface of the support, means for displacing the moving parts radially inward and outward, and means for measuring the relative displacements of the moving parts as well as the stresses sustained by these parts.

Advantageously, the tool has a radially external shape that is substantially cylindrical in rotation, adapted to be pressed against at least one part of the radially internal surface of the support.

The testing device according to the invention can be such that, the tool comprising at least two parts moving relative to one another, each part has a radially external shape adapted to fit at least one circumferential portion of the radially internal surface of the support.

Advantageously, the radially external surface of the parts includes a surface coating with a low friction coefficient. This coating has the advantage of more effectively distributing the stresses transmitted by the parts to the internal surface of the support. This coating can be a plastic material such as Teflon®.

Alternatively, the radially external surface of the parts may include one or more rollers. The rollers serve the same purpose as the low friction coefficient coating, to more evenly distribute the stresses transmitted by the parts to the internal surface of the support.

It is also possible to provide means for lubricating the contact between the parts and the radially internal surface of the support.

Advantageously, the parts have a geometry adapted so as to have, in the position in which they are closest to one another, an external diameter smaller than the nominal internal diameter of the run-flat support. This makes it very easy to place the support around the tool.

Preferably, the tool comprises two parts. Applicant's tests have in fact demonstrated satisfactory reproducibility of the measurements, and this has the advantage of making it possible to use a much simpler device than if it had been necessary to have a tool with 3, 4 or 6 parts moving radially inward and outward.

### BRIEF DESCRIPTION OF THE DRAWINGS

FIG. 1 presents a schematic diagram of a side view in partial cross-section of a testing device according to the invention.

FIG. 2 presents a schematic diagram of a top view of a measuring tool of a device according to the invention;

FIG. 3 presents the tool of FIG. 2 in a position that allows a support to be put in place; and

FIG. 4 presents the tool of FIG. 2 in a measuring position.

### DETAILED DESCRIPTION OF THE DRAWINGS

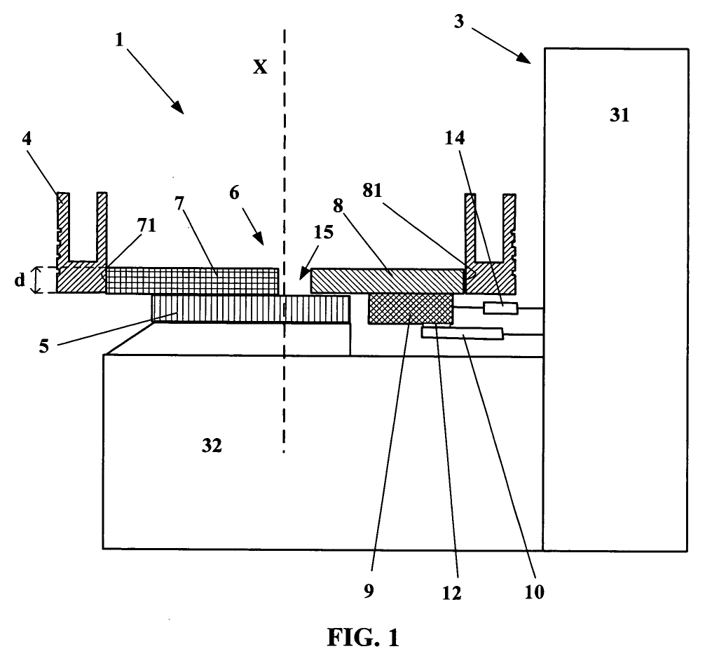

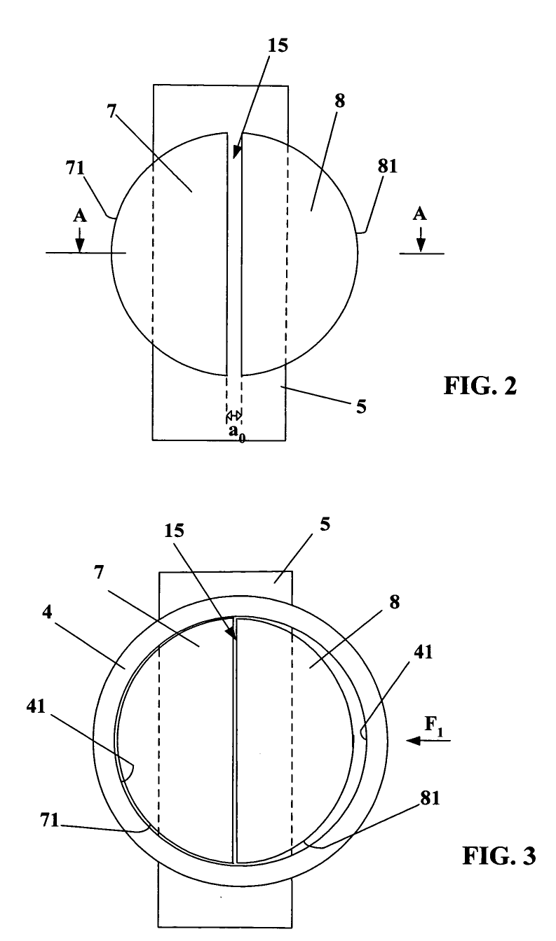

FIG. 1 presents a side view in partial cross-section of a device for testing run-flat tire supports according to the invention. The cutting line is along AA, as indicated in FIG. 2.

This device 1 chiefly comprises a frame 3, a holder 5 for receiving the supports 4, a measuring tool 6 comprising two parts 7 and 8, one moving 8, the other fixed 7, means for displacing 10 the moving part 8, and stress 12 and displacement 14 sensors connected to the moving part 8. In the example shown, the measuring tool 6 and the support 4 are disposed in a horizontal plane, hence with the axis of symmetry X for the vertical support.

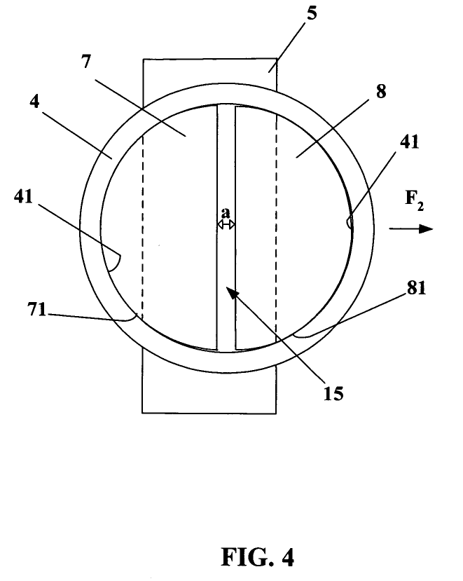

The holder 5 is rigidly joined to the bottom part 32 of the frame 3. As shown in FIGS. 3 and 4, this holder has the function of holding the support 4 in place when it is disposed around the measuring tool 6.

The measuring tool 6 comprises two parts 7 and 8. The part 7 is rigidly joined to the holder 5 and is immobile. The part 8 is joined to the part 31 of the frame 3 by means of a holder 9 and means 10 for translationally displacing the holder 9 and the part 8. These means 10 can include, for example, a rack, a micrometric sliding plate or a screw jack. A displacement sensor 14 for measuring the relative displacements of the parts 7 and 8 is disposed between the holder 9 and the frame 31. A stress sensor 12 is also disposed between the displacing means 10 and the holder 9 in order to monitor the stresses transmitted by the part 8 to the support 4.

As may be seen in FIGS. 2 through 4, the two parts 7 and 8 have a substantially semi-circular shape. The radius of each part is equal to that of the mounting rim of the support. The purpose of this is to allow the two radially external surfaces 71 and 81 of these two parts to snugly fit the radially internal surface of the support 4 during the measurements. The part 8 is translationally movable radially, both inward and outward, in the direction of the arrows F₁ and F₂ in FIGS. 3 and 4. The parts 7 and 8 have an axial height d smaller than the axial height of the supports 4. This makes it possible to apply stretching stresses on the part of the support to be disposed facing the inside of the vehicle. This part does not have any ribs or wedges for facilitating the compromise between the mounting and the centrifugal stressing of the supports. Consequently, the surfaces 41 and 71-81 can come into close contact, which improves both the precision of the measurement and its representivity. An order of magnitude of the height d is 20 mm.

In FIG. 2, the two parts 7 and 8 are disposed relative to one another so that their external surfaces 71 and 81 are inscribed in a circle with a diameter equal to the diameter of the mounting rim: φⱼ. The distance a₀ separates the two parts 7 and 8 in this reference position. It may be seen that between the two parts 7 and 8, there is an open strip 15. The purpose of this strip 15 is to make it possible to move the part 8 toward the part 7 when it is time to place the support 4 around the tool 6. This is what is shown in FIG. 3. The displacement of the part 8 in the direction F₁ allows the support to be put in place without difficulty.

After the placement of the radially internal surface 41 of the support 4 around the surfaces 71 and 81 of the parts 7 and 8, the moving part 8 is progressively moved away from the part 7. This displacement occurs radially, toward the outside. The result is that the surfaces 41 and 71-81 come into close contact and the part 8 applies increasing stresses on the surface 41. The resultant of these stresses is measured by the stress sensor 12.

As we have seen, the stretching stresses are only applied along a limited axial height of the radially internal surface of the supports. When these stresses reach a value on the order of 55 N/mm for supports made of rubber-like material of small size, or on the order of 80 N/mm for supports made of rubber-like material of larger size, this applied stress is kept constant while waiting for the displacement to stabilize for a few seconds, from 10 to 60, and the value a of the distance between the two parts 7 and 8 is measured.

The internal evolute or internal circumference of the support is calculated immediately:
P=π.φ_{J}+2.(a−a₀),
as is the effective diameter of the support:

$${Φ}_{A} = {Φ}_{J} + 2 \frac{. a - {a}_{0}}{π}$$

where P is the internal circumference of the support, φ_{A} is the effective diameter of the support, a is the distance between the two parts 7 and 8 under the given stretching stress, and a₀ is the reference distance between the two parts 7 and 8 for which their external surfaces are inscribed in a circle of diameter φ_{J} corresponding to the diameter of the mounting rim of the support.

The part 8 is then returned to its position near the part 8 and the support is released from the measuring rig.

Appropriate nominal values and tolerances are set for each support based on their properties and on current need.

FIG. 4 shows another embodiment of a measuring tool according to the invention.

In this embodiment, the tool includes only two parts for applying stresses to the internal surface of the supports, but the number of these parts could easily be increased to 3, 4, or 6. This would make it possible to apply a more uniform centrifugal stress field for stretching the internal surface of the supports. It would also be possible to apply a surface coating on the radially external surfaces of the parts 7 and 8 in order to reduce their friction coefficient, or to lubricate this contact surface or even incorporate rollers.

The embodiments presented have been given only as examples, and various modifications could be made by one skilled in the art without thereby going beyond the scope of the invention defined by the following claims.

I claim:

1. A method for testing a run-flat tire support, comprising the steps of:
performing at least one measurement representing at least one internal or external dimension of the support representing the effective internal diameter of said support,
wherein said measurement is performed while at least one part of the radially internal surface of the support is subjected to radial centrifugal stresses.

2. The testing method according to claim 1, further comprising performing a measurement representing the internal evolute or the internal circumference of said support.

3. The testing method according to claim 1 further comprising:
disposing said support around a tool, wherein said tool comprises at least two parts moving radially relative to one another, each part having a radially external surface with a shape adapted to fit a circumferential portion of the radially internal surface of said support;
radially moving said moving parts apart from one another, and pressing said radially external surfaces of said parts against at least one circumferential portion of the radially internal surface of said support until a given stretched condition of said radially internal surface of said support is produced; and
performing said measurement representing the effective internal diameter of said support

4. The testing method according to claim 3, wherein said moving parts are moved apart until stresses for stretching said radially internal surface of said support are applied at given values, and the corresponding displacement of said moving parts is measured.

5. The testing method according to claim 3, wherein said moving parts are moved a given distance apart and the corresponding resultant of the stresses exerted by the radially internal surface of said support on at least one of said parts is measured.

6. The testing method according to claim 5, wherein said measurement representing the effective internal diameter of said support is performed after a given stabilization time.

7. The testing method according to claim 1, wherein the radially external surface of said parts is pressed against a substantially smooth circumferential portion of the radially internal surface of said support.

8. The testing method according to claim 1, wherein the axial height of the radially external surface of the parts being d, the stresses applied per millimeter of axial height in order to stretch the radially internal surface of the support are between 40 and 150 N/mm.

9. The testing method according to claim 8, wherein the stresses applied in order to stretch the radially internal surface of the support are between 50 and 100 N/mm.

10. A device for testing a run-flat tire support, comprising:
a run-flat support holder;
a tool for exerting outward radial stress on at least one part of the radially internal surface of said support comprising at least two parts moving radially relative to one another so as to stretch said radially internal surface;
means for displacing said moving parts radially inward and outward; and
means for measuring the relative displacements of said moving parts as well as the stresses sustained by said parts.

11. The testing device according to claim 10, wherein said tool has a radially external surface with a shape that is substantially cylindrical in rotation, adapted to be pressed against at least one part of the radially internal surface of said support.

12. The testing device according to claim 11, wherein said tool comprising at least two parts moving relative to one another, each part has a radially external surface with a shape adapted to fit at least one circumferential portion of the radially internal surface of said support.

13. The testing device according to claim 12, wherein the radially external surface of said parts includes a surface coating with a low friction coefficient.

14. The testing device according to claim 12, wherein the radially external surface of said parts may include at least one roller.

15. The testing device according to claim 12, comprising means for lubricating the contact between the parts and the radially internal surface of the support.

16. The testing device according to claim 10, wherein said parts have a geometry adapted so as to have, in the position in which they are closest to one another, an external diameter smaller than the nominal internal diameter of the run-flat support.

17. The testing device according to claim 10, wherein said tool comprises two parts.

18. The testing method according to claim 4, wherein said measurement representing the effective internal diameter of said support is performed after a given stabilization time.
